(19) United States
(12) Patent Application Publication
(10) Pub. No.: US 2007/0172239 A1
(43) Pub. Date: Jul. 26, 2007

(54) Optical transmission system

(76) Inventors: Tomotaka Yamazaki, Yokohama (JP); Ryuji Ishii, Yokohama (JP); Shinji Sakano, Kamakura (JP); Nobuaki Tajimi, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/526,604

(22) Filed: Sep. 26, 2006

(30) Foreign Application Priority Data
Jan. 25, 2006 (JP) 2006-015983

(51) Int. Cl. H04J 14/00

(52) U.S. Cl. 398/68

(57) ABSTRACT

It is configured to have a first optical line terminal for transmitting a video signal of a first wavelength; a second optical line terminal for transmitting a downstream data signal of a second wavelength and receiving an upstream data signal of a third wavelength; and a wavelength division multiplexer for wavelength division multiplexing the video signal and the upstream data signal and the descend data signal, where an attenuator is provided between the second optical line terminal and the wavelength division multiplexer, the attenuator having a characteristic that an attenuation amount given to the second wavelength is larger than an attenuation amount given to the third wavelength.

### Claim of Priority

The present application claims priority from Japanese patent application serial no. 2006-015983, filed on Jan. 25, 2006, the content of which is hereby incorporated by reference into this application.

### BACKGROUND OF THE INVENTION

1. Field of the Invention

The present invention relates to an optical transmission system, and particularly to an optical transmission system for three wavelengths division multiplexing with one fiber that unites broadcasting and communication.

2. Description of the Related Art

There has been put into practical use a passive optical network (PON) that connects one optical line terminal (OLT) installed in a central office and a plurality of optical network units (ONUs) installed in subscriber homes by optical fibers via a splitter. The PON can reduce the cost per subscriber as it enables sharing the optical fiber from the OLT to the splitter by each of the subscribers. The splitter (also called as the star coupler) is a passive element with no power supply necessary, and has an excellent maintainability.

The initial PON was specific to communication. However, there is a plan to receive television broadcast in the subscriber homes by adding a video-OLT (V-OLT) to the central office to multiplex with the optical signal the OLT receives. The OLT itself has a wavelength division multiplexing section inside thereof, transmitting and receiving upstream data signals and downstream data signals. Accordingly, the total number of multiplexed wavelengths is three. This PON for three wavelengths division multiplexing with one fiber is standardized by ITU-T, which uses a wavelength of 1.49 μm (micrometers) for the downstream data signal, 1.55 μm for the downstream video signal, and 1.31 μm for the upstream data signal, respectively.

The PON for three wavelengths division multiplexing with one fiber and its equipment performance conditions are described in Document 2 at pages 46 to 47.

Meanwhile, in Document 1, there is described a dielectric multilayer filter having a fluorinated polyimide substrate with a smaller refractive index on which TiO2 and SiO2 are alternately formed using an ion assisted deposition method. An application of inserting the filter between two optical fibers is also described. Incidentally, although the filter is described in Document 1, the dielectric multilayer filter can obtain a loss wavelength characteristic (wavelength selectivity) that changes the loss depending on the wavelength due to the interference within the multilayer. There is known a gain equalizer using the dielectric multilayer that equalizes the gain of the erbium-doped fiber amplifier by taking advantage of the loss wavelength characteristic.

Document 1: Japanese Patent Publication Laid-Open No. HEI 4 (1992)-211203

Document 2: “Transmission Technology and Installation of FTTH Cable Television System” edition 1.0, published by Japan Cable Television Engineering Association (JCTEA); Apr. 27, 2005; pages 46 to 47, 54, 59

The PON for three wavelengths division multiplexing with one fiber to which the V-OLT is added has a problem of Stimulated Raman Scattering (SRS). This is the problem that the energy of the downstream data signal with the wavelength 1.49 μm moves to the longer wavelength side due to SRS, thereby having an effect on the downstream video signal with the wavelength 1.55 μm.

There is a description on SRS and crosstalk due to SRS in Document 2 at pages 54 and 59.

### SUMMARY OF THE INVENTION

It is configured to have a first optical line terminal for transmitting a video signal of a first wavelength; a second optical line terminal for transmitting a downstream data signal of a second wavelength, and receiving an upstream data signal of a third wavelength; and a wavelength division multiplexer for wavelength division multiplexing the video signal and the upstream data signal and the downstream data signal, where an attenuator is provided between the second optical line terminal and the wavelength division multiplexer, the attenuator having a characteristic that an attenuation amount given to the second wavelength is larger than an attenuation amount given to the third wavelength.

Further, it is configured to have a first optical line terminal for transmitting a video signal of a first wavelength; a second optical line terminal for transmitting a downstream data signal of a second wavelength, and receiving an upstream data signal of a third wavelength; a wavelength division multiplexer for wavelength division multiplexing the video signal and the upstream data signal and the downstream data signal; an optical network unit for receiving the video signal and the downstream data signal and transmitting the upstream data signal; and a splitter provided between the wavelength division multiplexer and the optical network unit, where an attenuator is provided between the splitter and the optical network unit, the attenuator having a characteristic that an attenuation amount given to the second wavelength is larger than an attenuation amount given to the third wavelength..

### BRIEF DESCRIPTION OF THE DRAWINGS

Preferred embodiments of the present invention will now be described in conjunction with the accompanying drawings, in which:

FIG. 1 is a block diagram of an optical transmission system;

FIGS. 2A and 2B are diagrams illustrating the background noise of a video signal;

FIG. 3 is a diagram illustrating the relation between the optical output to an optical fiber and CNR of the downstream data signal;

FIG. 4 is a diagram illustrating the relation between the wavelength and the attenuation amount of an ATT;

FIG. 5 is a diagram illustrating a level diagram of the optical transmission system;

FIG. 6 is a perspective view of an OLT and a wavelength dependent type optical attenuator;

FIG. 7 is a block diagram of the optical transmission system; and

FIG. 8 is a diagram illustrating a level diagram of the optical transmission system.

### DESCRIPTION OF THE PREFERRED EMBODIMENTS

Hereinafter, the mode for carrying out the present invention will be described using embodiments with reference to the accompanying drawings. The same reference numerals are given to substantially the same portions, and the description thereof will not be repeated.

### Embodiment 1

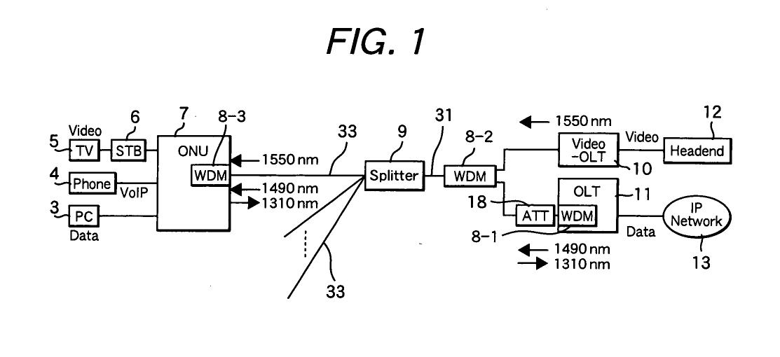

Embodiment 1 will be described with reference to FIGS. 1 to 6. Here, FIG. 1 is a block diagram of an optical transmission system.

An optical line terminal (hereinafter referred to as OLT) 11 installed in a central office incorporates a wavelength division multiplexer (WDM) 8-1 and an optical transmitter and optical receiver, which are not shown. The OLT 11 is connected to an IP network 13. In this state, the Internet connection of a subscriber is realized, and then the television broadcasting service is started. Television broadcast is transmitted through an optical fiber in such a way that V-OLT 10 connected to a headend 12 for delivering television broadcast transmits an optical signal that a video signal is modulated to a carrier signal of 100 channels (61.25 to 655.25 MHz) at an interval of from 61.25 to 6 MHz.

This video signal has a wavelength of 1.55 μm and an optical output of 19.5 dBm. The video signal from the V-OLT 10 and the downstream data signal (1.49 μm) from the optical transmitter of the OLT 11 are wavelength multiplexed by a wavelength division multiplexer 8-2, and transmitted to the subscriber home via an optical fiber 31. The upstream data signal (1.31 μm) from the subscriber home is wavelength divided by the wavelength division multiplexer 8-2, and transmitted to the OLT 11. This upstream data signal is divided by the wavelength division multiplexer 8-1 within the OLT 11, and received by the optical receiver. Incidentally, the downstream data signal of the OLT 11 has an optical output of 4 dBm and is closer to the short wavelength side than the video signal is located,.which causes crosstalk due to SRS in the video signal unless an appropriate measure is taken to prevent it.

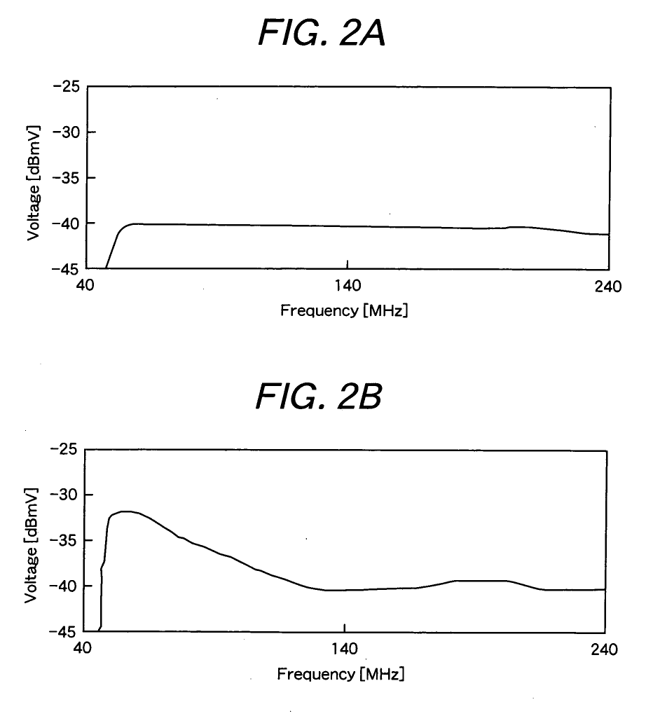

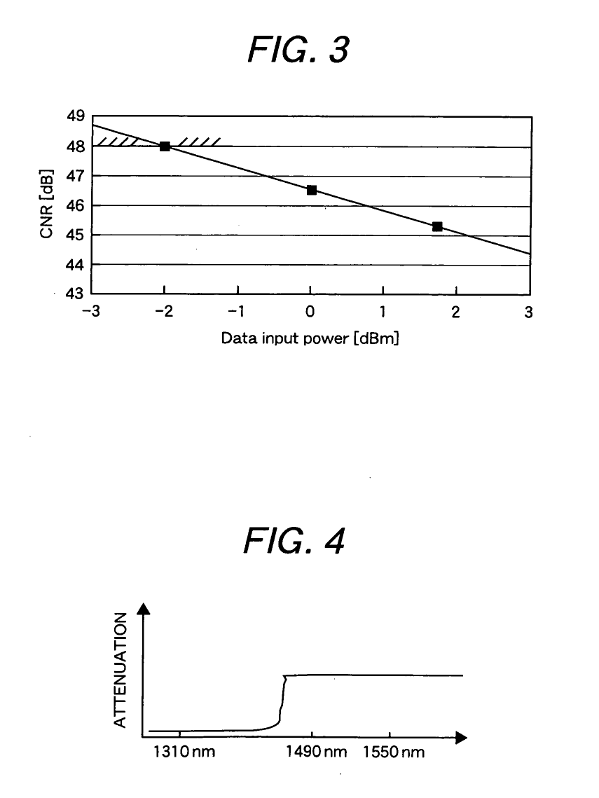

The crosstalk will be described with reference to FIGS. 2A, 2B and 3. Here, FIGS. 2A and 2B are diagrams illustrating the background noise of a video signal. FIG. 3 is a diagram illustrating the relation between the optical output to an optical fiber and CNR of a downstream data signal.

In FIGS. 2A and 2B, the vertical axis represents the optical power level, and horizontal axis represents the frequency. FIG. 2A shows the background noise of a video signal with no downstream data signal. FIG. 2B shows the noise of a video signal with the downstream data signal superimposed thereon, where a crosstalk noise appears at frequencies from 50 to 120 MHz.

The dependency of the crosstalk due to SRS and the strength of the downstream data optical signal will be described with reference to FIG. 3. The crosstalk due to SRS degrades a carrier-to-noise ratio (CNR). In FIG. 3, the horizontal axis represents the optical power level of the downstream data signal which is input to an optical fiber (length of 25 km), and the vertical axis represents the CNR of the received video signal which has been wavelength multiplexed with the downstream data signal. Downstream data signals of −2 dBm, 0 dBm, and 1.7 dBm were transmitted through the optical fiber together with the video signal, and the CNR was measured. As a result, it was found that it was necessary to set the optical level of the downstream data signal at the input end of the optical fiber, equal to or less than −2 dBm, in order to meet the CNR specification 48 dB or more.

Return to FIG. 1, an attenuator (ATT) 18 having a wavelength dependency is connected to the wavelength division multiplexer 8-1 of the OLT 11. Through the attenuator 18, the optical strength of the downstream data signal is decreased by 4.5 dBm, and a downstream data signal of −0.5 dBm is delivered to the wavelength division multiplexer 8-2. The upstream data signal of the wavelength 1.31 μm also passes through the optical attenuator 18, which is slightly attenuated due to the wavelength dependency of the attenuator 18 and received by the OLT 11.

The downstream signal (the video signal and the downstream data signal) reaches a splitter 9 via the optical fiber 31, and divided into 32 signals. Each of the divided signals is transmitted to a subscriber home via an optical fiber 33. An optical network unit (hereinafter referred to as ONU) 7 located in the subscriber home incorporates a wavelength division multiplexer 8-3 and two independent units, an optical receiver and an optical transmitter, which are not shown. The ONU 7 is connected to a set top box (STB) 6 and an IP telephone 4 and a PC 3. The STB 6 is connected to a television 5.

The ONU 7 converts the received video optical signal to a video electrical signal, and transmits the converted signal to the STB 6. The STB 6 selects a channel and causes the television 5 to run the selected channel program. The ONU 7 converts the received downstream data signal to an electrical signal, and transmits the data addressed to the own unit, to the IP telephone 4 or PC 3. Incidentally, the ONU 7 discards data addressed to other than the own unit. The ONU 7 further converts the electrical signal that the IP telephone 4 and the PC 3 have transmitted, to an upstream data signal (optical signal) according to a schedule defined by the OLT 11. Then the ONU 7 transmits the upstream data signal toward the splitter 9 via the incorporated WDM 8-3 and the optical fiber 33.

The splitter 9 consolidates the upstream data signals from the subscribers, and transfers to the OLT 11 via the optical fiber 31, WDM 8-2, and the wavelength dependent type optical attenuator 18.

Here, the characteristic of the optical attenuator (ATT) having the wavelength dependency will be described with reference to FIG. 4. Here, FIG. 4 is a diagram illustrating the relation between the wavelength and attenuation amount of the wavelength dependent type optical attenuator. In FIG. 4, the wavelength dependent type optical attenuator 18 hardly gives attenuation when the wavelength of the light passing therethrough is 1.31 μm. On the other hand, when the light wavelengths of the light passing therethrough are 1.49 μm and 1.55 μm, the wavelength dependent type optical attenuator 18 gives an attenuation of 4.5 dBm to the light passing therethrough. Such a characteristic may be obtained by a dielectric multilayer filter and the like. It is also possible to give the attenuation exclusively to the wavelength 1.55 Am. Further, the attenuation amount can be made arbitrary large or small.

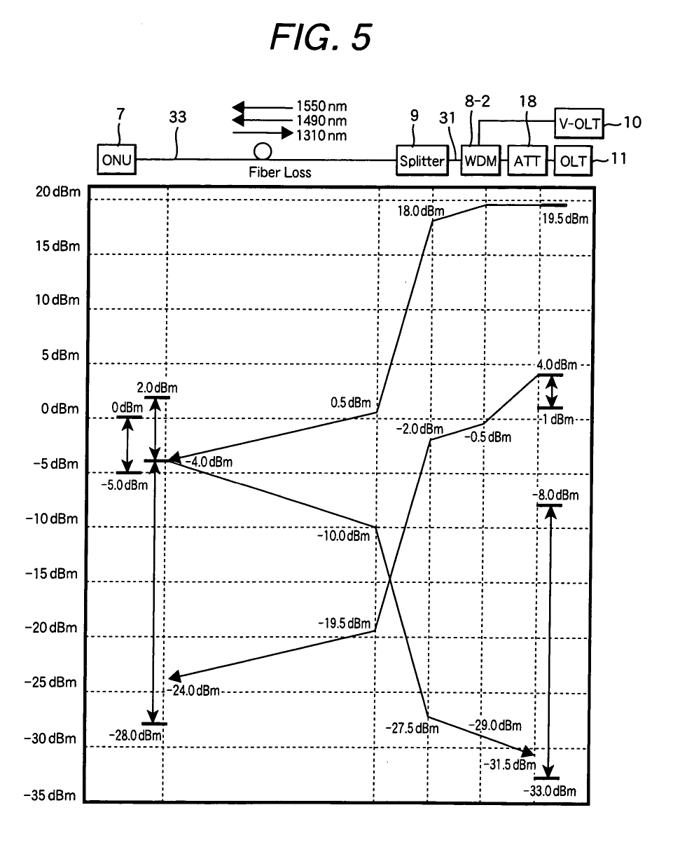

Next, the signal level of each point of the optical transmission system of FIG. 1 will be described with reference to FIG. 5. Here, FIG. 5 is a diagram illustrating a level diagram of the optical transmission system. In FIG. 5, a block diagram illustrating the measurement points of the optical transmission system is descried at the top of the figure, and the levels of each of the optical signals are described therebelow. Incidentally, the insertion losses of the WDMs 8-1, 8-3 within the OLT 11 and ONU 7 respectively, are taken into account in the values of the transmission level or the receivable level. The optical level of the video signal the V-OLT 10 transmits is 19.5 dBm, the optical level of the downstream data signal the OLT 11 transmits is 4 to 1 dBm, and the optical level of the upstream data signal the ONU 7 transmits is 2 to −4 dBm. The receivable range of the video signal of the ONU is 0 to −5 dBm, and the receivable range of the downstream data signal is −4 to −28 dBm. Further, the receivable range of the upstream data signal of the OLT 11 is −8 to −33 dBm.

In FIG. 5, the video signal of 1.55 μm is transmitted from the V-OLT 10, and reaches the WDM 8-2 without passing through the wavelength dependent type optical attenuator 18. The initial transmission level of the video signal is 19.5 dBm. The video signal passes through the WDM with a loss (1.5 dBm) equivalent to the insertion loss of the WDM. The video signal incurs a loss also in the fiber 31, but the evaluation of the loss is included in the fiber 33. The splitter 9 transmits one thirty-second of the energy of the video signal, to the optical fiber 33. Accordingly, the loss of the splitter 9 is as large as 17.5 dBm. The length of the optical fiber 33 downstream of the splitter 9, together with the optical fiber 31, is as long as up to 15 km, over which the video signal incurs a loss of 4.5 dBm and reaches the ONU 7. The reached video signal level (−4 dBm) is within the video signal receivable range, so that the video signal is normally received.

On the other hand, the downstream data signal (1.49 μm) is output from the OLT 11 at the specification upper limit of 4 dBm. The output signal is attenuated by 4.5 dBm in the wavelength dependent type optical attenuator 18 and by 1.5 dBm in the WDM 8-2. Then the signal is input to the optical fiber 31 at −2 dBm. This value is the value satisfying the CNR specification 48 dBm or more, which has been described in FIG. 3. The downstream data signal incurs a loss of 17.5 dBm in the splitter 9, and a loss of 4.5 dBm in the optical fibers 31, 33, and then the signal reaches the ONU 7 at an optical level of −24 dBm. Incidentally, even if the transmission optical level of the downstream data signal is the specification lower limit of 1 dBm, the downstream data signal reaches the ONU 7 at −27 dBm.

Assuming that the upstream data signal (1.31 μm) the ONU 7 transmits is output at the specification lower limit of −4 dBm. The loss of the signal with the wavelength of 1.3 μm band in the optical fiber is larger than the signal with the wavelength of 1.5 μm band, so that the signal incurs a loss of 6 dBm in the optical fibers 33, 31. The upstream data signal incurs a loss of 17.5 dBm in the splitter 9, 1.5 dBm in the WDM 8-2, and 1.5 dBm in the wavelength dependent type optical attenuator 18, respectively, and then the signal reaches the OLT 11 at −31.5 dBm. This optical level is within the receive specification of the upstream data signal, so that the signal is normally received. Incidentally, the receive dynamic range of the upstream data signal is large in the OLT 11, and there is obviously no problem to receive the upstream data signal which the ONU 7 transmits even if the optical level is the specification upper limit.

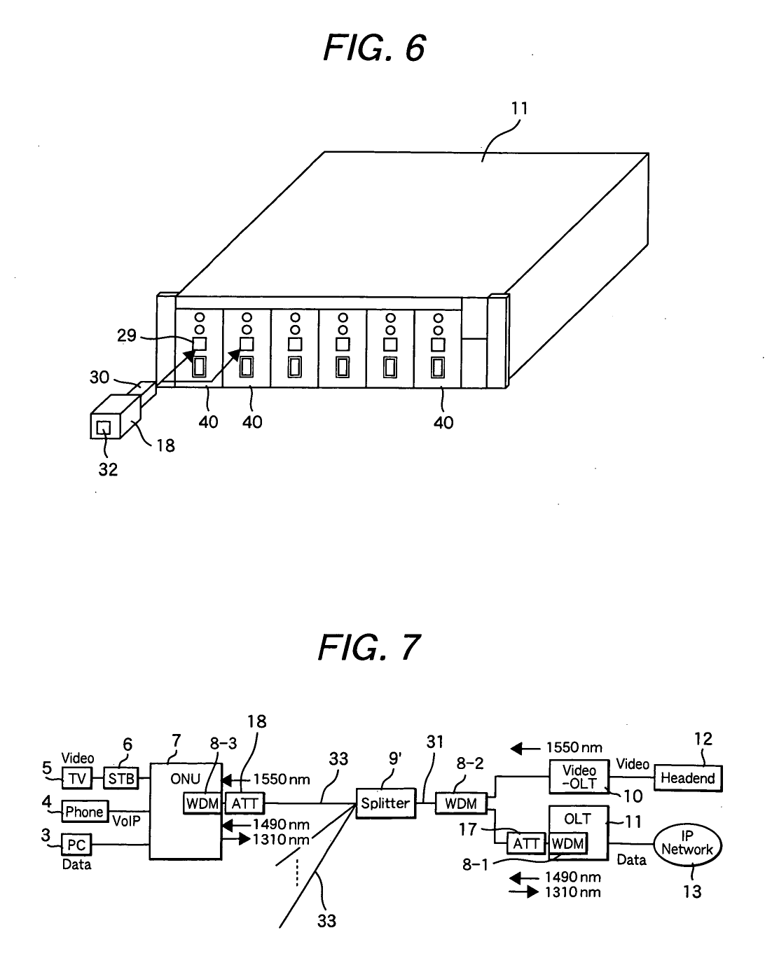

The implementation of the wavelength dependent type optical attenuator 18 to the OLT 11 will be described with reference to FIG. 6. Here, FIG. 6 is a perspective view of the OLT and the wavelength dependent type optical attenuator. In FIG. 6, the OLT 11 is rack mountable and has six circuits as PON interfaces 40. A front panel of the PON interface 40 is provided with a PON port (receptacle) 29. Connecting the fiber 31 to the PON port 29 enables the subscriber to connect to the Internet. However, in the embodiment, a plug 30 of the wavelength dependent type optical attenuator (ATT) 18 is inserted into the PON port 29, and a fiber to the WDM 8-2 is connected to a receptacle 32 provided on the opposite side of the plug 30 of the wavelength dependent type optical attenuator 18. Such a configuration is easily established, because the dielectric multilayer filter used for the wavelength dependent type optical attenuator 18 is a thin film which is just provided between the optical fiber used for the plug 30 and the optical fiber used for the receptacle 32. Further, the configuration of the wavelength dependent type optical attenuator 18 may be flexible, as long as it is provided with a plug at an end thereof and a receptacle at the other end thereof.

The attenuation amount of the wavelength dependent type optical attenuator 18 relative to the 1.49 μm wavelength is not limited to 4.5 dBm, and may be made larger or smaller than this value depending on how the dielectric multilayer filter is created. Further, the wavelength dependent type optical attenuator 18 is configured as a relay connector, which facilitates the change of the attenuation amount.

According to the embodiment, OLT for data communication can be converted into OLT for three wavelengths with one fiber including the video signal, without any alterations.

### Embodiment 2

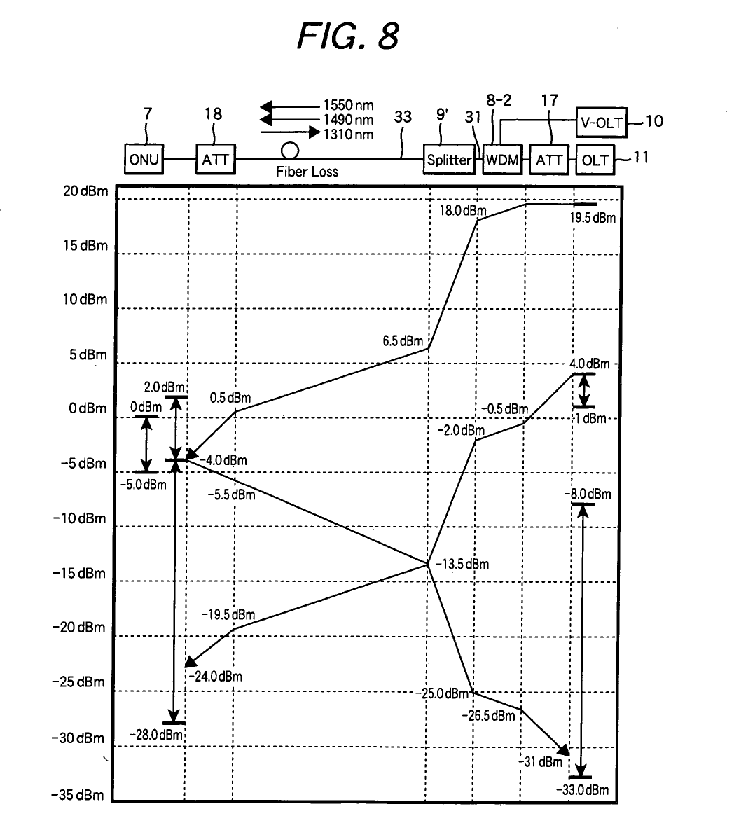

Embodiment 2 will be described with reference to FIGS. 7 and 8. Here, FIG. 7 is a block diagram of the optical transmission system. FIG. 8 is a diagram illustrating a level diagram of the optical transmission system.

The transmission system shown in FIG. 7 has substantially the same configuration as the transmission system according to Embodiment 1. However, in Embodiment 1, the optical attenuator 18 with wavelength selectivity is connected to the OLT 7, whereas in Embodiment 2 an optical attenuator 17 without wavelength selectivity is connected to the OLT 7. The splitter 9 according to Embodiment 1 features 32 branches, whereas a splitter 9′ according to Embodiment 2 features 8 branches. The total length of the optical fibers 31, 33 is 15 km in Embodiment 1, whereas 20 km in Embodiment 2. In addition, the wavelength dependent type optical attenuator 18 is inserted between the optical fiber 33 and the ONU 7 in the subscriber home according to Embodiment 2. The wavelength dependent type optical attenuator 18 according to Embodiment 1 is provided at the outlet port of the OLT 11, and attenuates all the downstream data signals to all the subscribers. Meanwhile, a wavelength dependent type optical attenuator 18-2 according to Embodiment 2 is provided at the inlet port-of the ONU, and attenuates the downstream data signal and video signal to specific subscribers. In other words, the optical level adjustment can be made when the extension distance of the optical fiber is significantly different among the subscribers.

Now, the effect of the above described difference on the level diagram will be described with reference to FIG. 8. The loss of the video signal by the splitter 9′ is 11.5 dBm. This is smaller by 6 dBm as the number of branches is one fourth of the splitter 9. The loss is 6 dBm as the total length of the fibers is extended. Further, the video signal of the wavelength 1.55 μm incurs the loss of 4.5 dBm, as the wavelength dependent type optical attenuator 18 is mounted to the ONU 7. The loss amounts of the downstream data signal by each of the optical components are the same as the video signal. For the upstream data signal, the losses by the splitter 9′ and the optical fibers 33, 31 are the same as described above. However, since the wavelength dependent type optical attenuator 18 is mounted to the ONU 7, the upstream data signal of the wavelength 1.31 μm incurs the loss of 1.5 dBm. The optical attenuator 17 without wavelength selectivity gives the loss of 4.5 dBm to every wavelength. Thus, the upstream data signal incurs the loss of 4.5 dBm by the optical attenuator 17. The optical level of the upstream data signal the OLT 11 receives is −31 dBm which is close to the specification lower limit. This means that the reception is disabled when the optical attenuator mounted to the ONU 7 has no wavelength selectivity.

In the above described embodiment, the optical attenuator 17 without wavelength selectivity is connected to the OLT 11, but the optical attenuator 18 with wavelength selectivity may be connected to the OLT 11. In this case, the margin of the upstream data signal can be further improved.

According to the embodiment, the optical level adjustment for each subscriber can be easily performed.

According to the optical transmission system according to the present invention, the video can be delivered in the way of addition to the existing optical transmission system.

We claim:

1. An optical transmission system comprising:
a first optical line terminal for transmitting a video signal of a first wavelength;
a second optical line terminal for transmitting a downstream data signal of a second wavelength, and receiving an upstream data signal of a third wavelength; and
a wavelength division multiplexer for wavelength division multiplexing said video signal and said upstream data signal and said downstream data signal,
wherein an attenuator is provided between said second optical line terminal and said wavelength division multiplexer,
said attenuator having a characteristic that an attenuation amount given to said second wavelength is larger than an attenuation amount given to said third wavelength.

2. An optical transmission system comprising:
a first optical line terminal for transmitting a video signal of a first wavelength;
a second optical line terminal for transmitting a downstream data signal of a second wavelength, and receiving an upstream data signal of a third wavelength;
a wavelength division multiplexer for wavelength division multiplexing said video signal and said upstream data signal and said downstream data signal; and
an optical network unit for receiving said video signal and said downstream data signal, and transmitting said upstream data signal,
wherein an attenuator is provided between said second optical line terminal and said wavelength division multiplexer,
said attenuator having a characteristic that an attenuation amount given to said second wavelength is larger than an attenuation amount given to said third wavelength.

3. An optical transmission system comprising:
a first optical line terminal for transmitting a video signal of a first wavelength;
a second optical line terminal for transmitting a downstream data signal of a second wavelength, and receiving an upstream data signal of a third wavelength;
a wavelength division multiplexer for wavelength division multiplexing said video signal and said upstream data signal and said downstream data signal;
an optical network unit for receiving said video signal and said downstream data signal, and transmitting said upstream data signal; and
a splitter provided between said wavelength division multiplexer and said optical network unit,
wherein an attenuator is provided between said splitter and said optical network unit,
said attenuator having a characteristic that an attenuation amount given to said second wavelength is larger than an attenuation amount given to said third wavelength.

4. The optical transmission system according to claim 1,
wherein said attenuator includes a plug section to which said second optical line terminal is connected and a receptacle section to which a fiber is connected.

5. The optical transmission system according to claim 2,
wherein said attenuator includes a plug section to which said second optical line terminal is connected and a receptacle section to which a fiber is connected.

6. The optical transmission system according to claim 3,
wherein said attenuator includes a plug section to which said second optical line terminal is connected and a receptacle section to which a fiber is connected.

7. The optical transmission system according to claim
wherein said attenuator obtains an attenuation characteristic that depends on the wavelength by a dielectric multilayer filter.

8. The optical transmission system according to claim 2,
wherein said attenuator obtains an attenuation characteristic that depends on the wavelength by a dielectric multilayer filter.

9. The optical transmission system according to claim 3,
wherein said attenuator obtains an attenuation characteristic that depends on the wavelength by a dielectric multilayer filter.
